(19) United States
(12) Patent Application Publication
(10) Pub. No.: US 2010/0180826 A1
(43) Pub. Date: Jul. 22, 2010

(54) Auto pet

(76) Inventor: Paul Gregory Fioritti, Burnaby (CA)

Correspondence Address: Paul Fioritti, 8654 Armstrong Ave, Burnaby, BC, V3N-2H6, CA

(21) Appl. No.: 12/658,625

(22) Filed: Feb. 12, 2010

Related U.S. Application Data
(63) Continuation of application No. 11/507,053, filed on Aug. 21, 2006, now abandoned.

(30) Foreign Application Priority Data
May 26, 2006 (CA) 2,548,238

(51) Int. Cl. A01K 7/00

(52) U.S. Cl. 119/61.54

(57) ABSTRACT

It is common knowledge that dogs require access to water several times a day to maintain good health. Dogs are also a important part of the family and often travel with the family in the car on a daily basis.

The present device (spill proof water dish) was designed to make water available to dogs who may be traveling in cars and while away from home. It is a fact that the temperature inside cars can be much higher than normal especially in warm climates. The present device (spill proof water dish) has been designed to open automatically when dogs want water. The present device (spill proof water dish) is also designed to be filled with ice which keeps the water fresh and cool even on a hot day away from home.

This document is to be filed as a continuation of application Ser. No. 11/507,053. This document has been modified since the time of the original application on Aug. 21, 2006.

The present device is a spill proof container designed to provide water to dogs while traveling inside automobiles. I previously had referred to this invention as Auto Pet. I have recently been granted a trademark for this device and it is now registered in Canada as “The TravelSafe water dish for dogs”.

The TravelSafe water dish has 4 main components listed as follows: The first component is the container itself, also referred to as the base of the dish. The base of the dish measures 12 inches in length, 7 inches in width and is 4 inches in height. The second component is the removeable rubber lid which is 12 inches in length, 7 inches width and 1 inch in height. The removeable rubber lid snaps to the perimiter of the base of the dish and has a large opening measuring 10 inches by 5 inches to allow access to the moveable flaps. The third component is the hinged moveable flaps which are mounted to the raised portion of the base of the dish. And finally the last component is the spring that will cause the hinged moveable flaps to return to the underside of the rubber lid.

### BACKGROUND

This device relates to the need dogs have for water while traveling in automobiles especially during hot weather. This device also relates to preventing water spills.

### FIELD OF INVENTION

It is common knowledge that dogs are always in need of water and that people bring their dogs with them while traveling in their automobiles on an every day basis. This device was created to serve two needs. The first need that this device serves is to provide water to dogs while traveling inside automobiles where water is usually not available. The second need this device serves is to provide a spill proof source of water to dogs.

The importance of this device reates to the difficulty dogs have keeping their body temperature low and their bodies hydrated especially during hot climates. It has been proven that serious brain damage and death may occur to dogs that have no access to water in hot climates as a result of overheating their bodies. The present device could be used in any vehicle that transports dogs and will also provide a spillproof source of water in the home.

### ADVANTAGES

I list the following as advantages to the present device described as a spill proof water dish for dogs. 1. The present device has a removeable rubber lid to allow the inside of the dish to be cleaned as needed. 2. The present device has been designed with the hinged moveable flaps being located 1 inch below the top of the dish to enhance its ability to not spill water. 3. The present device allows access to water when slight downward pressure is being applied to the hinged moveable flaps (opens automatically with downward pressure). 4. The present device makes use of a spring to return the hinged moveable flaps to the underside of the removeable rubber lid. (closes automatically) which creates a seal that makes this water dish spill proof even if turned up side down. 5. The present device makes use of clear plastic hinged moveable flaps to allow dogs to see the water inside the dish.

### OPERATION

The operation of the present device is as follows: Secure the rubber lid to the base of the dish itself by pressing down until the lid snaps into position. Fill the inside of the dish with water. Filling can be done by pouring water on top of the hinged moveable flaps. The weight of the water will cause the hinged moveable flaps to open automatically allowing the dish to be filled. Once the dish is full of water the spring will cause the hinged moveable flaps to return to the underside of the rubber lid (closed position). Now the spill proof water dish is ready for use.

When the dog wants water he will place his mouth or paw on the hinged moveable flap causing the flap to travel downward into the container thus creating access to the water (opens automatically).

When there is no weight on top of the hinged moveable flap and the dog is finished drinking the spring will cause the hinged moveable flaps to return to the underside of the rubber lid (closes automatically). This will create a seal that will prevent water from spilling while not in use.

### DESCRIPTION OF DRAWING

FIG. 1.

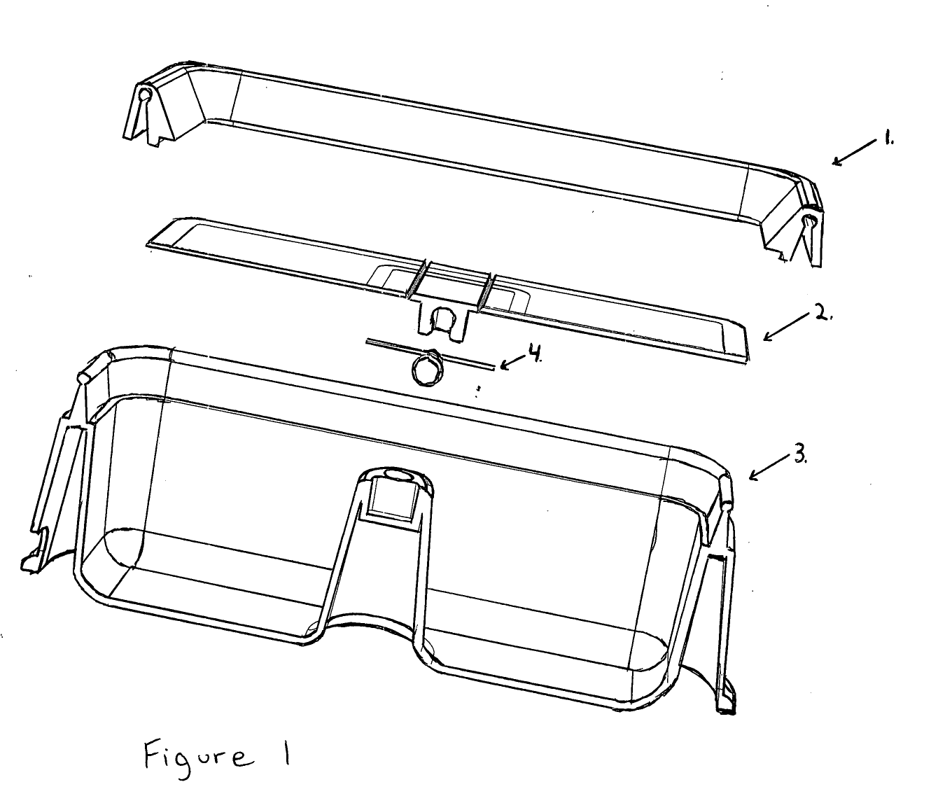

(1) is a cross sectional view of the removeable rubber lid.

(2) is a cross sectional view of the hinged moveable flaps

(3) is a cross sectional view of the base of the water dish

(4) is an image of the steel spring that serves to close the hinged moveable flaps automatically

1. The present device is a spill proof water dish for dogs with a removeable rubber lid to allow the inside of the dish to be cleaned when needed.

2. The present device is a spill proof water dish for dogs designed with moveable flaps being located 1 inch below the top of the dish to enhance its ability to not spill water.

3. The present device is a spill proof water dish for dogs that allows access to water when slight downward pressure is being applied to the hinged moveable flaps. (opens automatically with downward pressure).

4. The present device is a spill proof water dish for dogs that makes use of 2 clear plastic hinged moveable flaps to allow the dogs to see the water inside the dish.

5. The present device is a spill proof water dish for dogs that uses a spring to keep the 2 hinged moveable flaps in contact with the underside of the rubber lid (closes automatically) which creates a seal that makes this dish spill proof even if turned up side down.
